(19) United States
(12) Patent Application Publication
(10) Pub. No.: US 2008/0208995 A1
(43) Pub. Date: Aug. 28, 2008

(54) ELECTRONIC MAIL PROCESSING METHOD AND ELECTRONIC MAIL PROCESSING SYSTEM

(75) Inventors: Noriyuki TAKAHASHI, Tokyo (JP); Toshio Dogu, Tokyo (JP)

Correspondence Address: HOGAN & HARTSON LLP, ONE TABOR CENTER, SUITE 1500, 1200 SEVENTEENTH ST, DENVER, CO, 80202, US

(73) Assignee: DIGITAL ARTS INC., TOKYO (JP)

(21) Appl. No.: 12/036,102

(22) Filed: Feb. 22, 2008

(30) Foreign Application Priority Data
Feb. 27, 2007 (JP) 2007-046893

(51) Int. Cl. G06F 15/16

(52) U.S. Cl. 709/206

(57) ABSTRACT

Even when setting a complicated spam judging condition, it is possible to reliably determine a necessary electronic mail in reality (i.e a mail that is not a spam mail), without deleting a necessary electronic mail or the like. Based on the assumption that an electronic mail from a mail address to which transmission was performed in the past has a high possibility of not being a spam mail, a transmission destination mail address of an electronic mail transmitted to outside the organization is recorded as a permitted mail address (Step 506-Step 510), and when a transmission source address of an electronic mail destined to inside the organization matches a mail address registered in a permitted mail address database (Step 511: Yes), processing is performed to unconditionally receive this electronic mail (Step 504).

### CROSS REFERENCE TO RELATED APPLICATION

The present application claims priority from a Japanese Patent Application No. 2007-046893 filed on Feb. 27, 2007 the contents of which are incorporated herein by reference.

### BACKGROUND

1. Technical Field

The present invention relates to an electronic mail processing method and an electronic mail processing system, and in particular relates to an effective technology for being applied to an electronic mail processing technology for efficiently excluding junk mails.

2. Description of the Related Art

Currently, an electronic mail system based on the Internet technology is widely used, and is about to be established as basic infrastructure in society. As many people started to use electronic mails, the electronic mails started to be used as advertisement media and so on, and the increase in one-sided junk mails (so-called “spam mail”), is becoming a social problem. In particular, junk mails are occasionally used in phishing or the like, and so the need for coping with junk mails is being increasing, in light of realizing social justice not only in light of enhancing the usability for users.

A method of coping with junk mails is to designate, as a target of warning, sorting, and deletion, an electronic mail that satisfies a predetermined condition (spam judging condition), in a computer system being a mail server or a mail client, for example as disclosed in the Japanese Patent Application Publication No. 2006-221586, the Japanese Patent Application Publication No. 2006-197028, and the Japanese Patent Application Publication No. 2006-157621, and so on. The electronic mail designated as a target of warning or sorting is examined by a user, and thereafter subjected to deletion by a user, and so on. Although the spam judging condition is designated by a provider of a system or software in some cases, a user normally designates the spam judging condition, and changes the spam judging condition for improvement depending on whether the judgment result was successful or not in the usage state.

### SUMMARY

However, with the spam judging condition in the conventional junk mail countermeasure, it has been difficult to set a detailed condition, it has been troublesome to improve (to study) a condition setting value to have a different condition for each user even if it is designed to realize detailed condition setting, or there is increased possibility to cause an accident where a necessary electronic mail in reality is misjudged as a spam mail and deleted as the condition becomes complicated.

Therefore, it is an object of an aspect of the innovations herein to provide an electronic mail processing system and an electronic mail processing method, which are able to reliably judge a necessary electronic mail (i.e. a mail that is not a spam mail) without deleting a necessary electronic mail in reality or the like even when a complicated spam judging condition is designated. The above and other objects can be achieved by combinations described in the independent claims. The dependent claims define further advantageous and exemplary combinations of the innovations herein.

An aspect of the innovations herein is explained as follows. That is, an electronic mail processing method according to an aspect of the innovations herein is based on the assumption that an electronic mail from a mail address to which transmission was performed in the past has a high possibility of not being a spam mail. Specifically, in an electronic mail processing method according to an aspect of the innovations herein, a transmission destination mail address of an electronic mail destined to outside the organization is recorded as a permitted mail address, and processing is performed so that, when a transmission source address of an electronic mail destined to inside the organization matches a mail address registered as a permitted mail address, this electronic mail is received unconditionally. By processing electronic mails in the described manner, it becomes possible to, easily and without an error, receive an electronic mail that can be substantially reliably judged as not being a spam mail without performing a complicated spam judgment. Hereinafter, an electronic mail processing method according to an aspect of the innovations herein and modification examples thereof are described.

An electronic mail processing method according to an aspect of the innovations herein includes: receiving process target electronic mail data; when the electronic mail data is attempted to be transmitted from inside an organization to outside the organization, recording a transmission destination mail address of the electronic mail data to a permitted mail address database, and transmitting the electronic mail data; and when the electronic mail data is attempted to be transmitted from outside the organization to inside the organization and a transmission source mail address of the electronic mail data is recorded in the permitted mail address database, transmitting the electronic mail data.

According to the electronic mail processing method described above, it is possible to record, to a database, a destination mail address to which mail transmission is performed once as a permitted mail address, and to judge that, when an electronic mail is received from the destination mail address, the electronic mail is not a spam mail by simply determining whether the transmission destination mail address matches a record inside the permitted mail address database. Therefore, the electronic mail processing method does not necessitate a spam judgment that applies a complicated spam judging condition. As a result, even in a junk mail countermeasure software that adopts a complicated spam judging condition, it is possible to reduce the possibility of misjudgment, and to enhance the reliability of the junk mail countermeasure. Moreover, registration to the permitted mail address database is automatically performed in transmitting an electronic mail, and so it is possible to automatically improve the spam countermeasure simply while usage by a user, without giving particular trouble to the user.

Note that “inside an/the organization” used here means inside an organization to which a computer system in which a mail server operates belongs, and normally an organization is defined by an IP address or a domain name of a network. For example, a mail address managed by the same domain name as the domain name of the computer system will be a mail address for “inside an/the organization”. However, an organization can be defined arbitrarily, and so when a plurality of domain names are managed as inside one organization, a case may occur where a mail address whose domain name is different from the domain name of the mail server is different is considered as “inside the organization”. A case may likewise occur where mail addresses managed by the same domain name are treated as “outside the organization” by internal differentiation of the users by software.

The above-described electronic mail processing method may further include: when the electronic mail data is attempted to be transmitted from outside the organization to inside the organization and a transmission source mail address of the electronic mail data is not recorded in the permitted mail address database, judging a prevention condition, transmitting the electronic mail data if the prevention condition does not match, and discarding the electronic mail data if the prevention condition matches. This arrangement may be made, for the purpose of judging a prevention condition by means of a normal filtering function.

The following are some examples of the prevention condition. Namely, the prevention condition matches when the transmission source mail address of the electronic mail data is registered in a prohibited mail address database. The prevention condition matches when an IP address of a transmission source host of the electronic mail data is registered in a prohibited host database. The prevention condition matches when a word contained in a title or a text of the electronic mail data is registered in a prohibited word database. The prevention condition does not match even when a word contained in a title or a text of the electronic mail data is registered in a prohibited word database, if the word is registered in a permitted word database.

Moreover, it is possible to add the following modification to the above-described electronic mail processing method. That is, recording the transmission destination mail address of the electronic mail data to the permitted mail address database may include: when the transmission destination mail address is recorded in the permitted mail address database, moving the transmission destination mail address to a head record of the permitted mail address database, and when the transmission destination mail address is not recorded in the permitted mail address database and a number of recorded records in the permitted mail address database has reached a maximum number of records, deleting a tail record of the permitted mail address database, and recording the transmission destination mail address as a head record of the permitted mail address database. According to the electronic mail processing method described above, a mail address having high usage frequency will be always and constantly renewed. A mail address having high usage frequency is considered as having high importance in general, and so it becomes possible not to delete such a mail address having high usage frequency from a permitted mail address database. In addition, by adequately selecting a maximum number of records for the permitted mail address database, it is possible to automatically delete, from the permitted mail address database, a mail address with which communication was performed in the past but communication has not been performed recently. A mail address with which communication has not been performed recently is considered as having relatively low importance, and so it can be said as highly convenient for a user to automatically delete such address data having low importance.

It should be noted here that the above-described electronic mail processing method and modification examples thereof can also be considered as an electronic mail processing system.

An aspect of the innovations herein has an advantage of preventing deletion of a necessary electronic mail in reality or the like, thereby reliably judging a necessary electronic mail (i.e. a mail that is not a spam mail) even when a complicated spam judging condition is designated.

The summary of the invention does not necessarily describe all necessary features of the present invention. The present invention may also be a sub-combination of the features described above.

### BRIEF DESCRIPTION OF THE DRAWINGS

FIG. 1 is a schematic diagram showing one example of a network to which an electronic mail processing system being one embodiment of the present invention is applied.

FIG. 2 is a block diagram showing one example of a hardware overview of a server system according to the present embodiment.

FIG. 3 is a block diagram showing one example of a function of the server system according to the present embodiment.

FIG. 4 is a block diagram showing one example of a mail filtering server according to the present embodiment.

FIG. 5A and FIG. 5B are a flowchart showing one example of an electronic mail processing method being one embodiment of the present invention.

FIG. 6 is a flowchart showing one example of prevention condition judgment, in the electronic mail processing method according to the present embodiment.

FIG. 7 is a flowchart showing one example of prevention condition judgment in the electronic mail processing method according to the present embodiment.

FIG. 8 is a flowchart showing one example of prevention condition judgment in the electronic mail processing method according to the present embodiment.

FIG. 9 is a flowchart showing one example of prevention condition judgment in the electronic mail processing method according to the present embodiment.

### DESCRIPTION OF EXEMPLARY EMBODIMENTS

The invention will now be described based on the preferred embodiments, which do not intend to limit the scope of the present invention, but exemplify the invention. All of the features and the combinations thereof described in the embodiment are not necessarily essential to the invention.

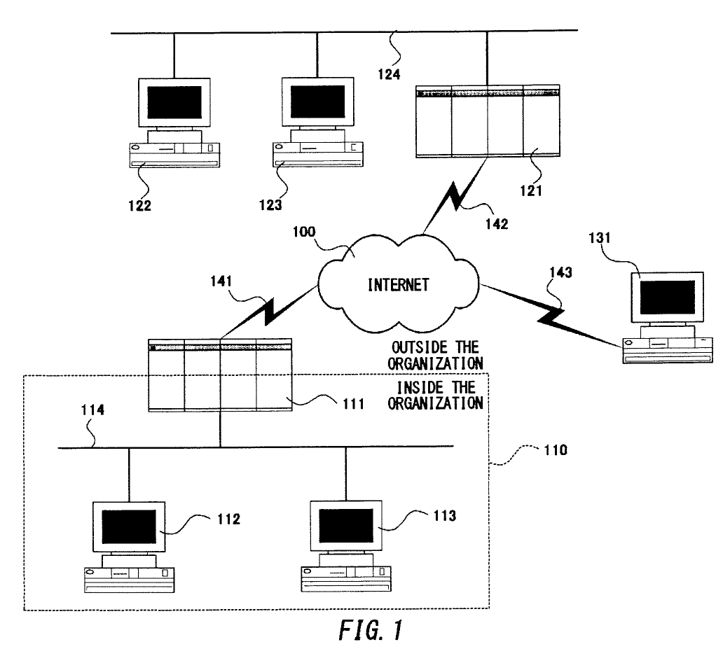

FIG. 1 is a schematic diagram showing one example of a network to which an electronic mail processing system being one embodiment of the present invention is applied. Existing inside an organization 110 are a server system 111, a PC (personal computer) 112 and a PC 113 connected to the server system 111 via a LAN (local area network) 114. Existing outside the organization 110 are a server system 121, a PC 122 and a PC 123 connected to the server system 121 via a LAN 124, and an independent PC 131. The server system 111, the server system 121, and the PC 131 are connected to the Internet 100 via communication links 141, 142, and 143.

A mail server and an electronic mail processing system (filtering server) according to the present embodiment are installed in the server system 111. The mail server and the filtering server operate in the server system 111. A WAN (wide area network)-side NIC (network interface card) in the server system 111 is associated with a global IP address, so that a domain name and a global IP address are associated by an adequate DNS (domain name server) operation. Accordingly, it becomes possible to access the server system 111 by designating a domain name corresponding to the server system 111 on the Internet. The LAN-side NIC of the server system 111 is associated with a private IP address or a server name. The PC 112 and the PC 113 can access the server system 111 by designating either a private IP address or a server name.

A mail client is installed in the PC 112 (113). A user of the PC 112 (113) has a mail account in the server system 111, and connects to the mail server of the server system 111 from the mail client of the PC 112 (113) by using this mail account. The details of the electronic mail system are well known to a person ordinarily skilled in the related art, and so the explanation thereof is omitted here.

The server system 121 is similar to the server system 111, except that it is not necessary that an electronic mail processing system according to the present embodiment be installed in the server system 121. The PC 122 and the PC 123 are similar to the PC 112 and the PC 113. A mail client is installed in the PC 131, just as in the PCs 112, 113, 122, and 123, however the PC 131 is connected to the Internet 100 by using an adequate ISP (Internet service provider). The account of a user of the PC 131 has been created in the mail server to which the mail client of the PC 131 connects, so that the mail server normally under management of the ISP is utilized.

“inside the organization 110” in FIG. 1 corresponds to a range of the PC 112 and the PC 113 connected to the server system 111 and the LAN 114. “inside the organization 110” corresponds to a range of the mail address managed under the same domain name as the domain name (i.e. global IP address) of the server system 111 when viewed from the Internet 100. In this example, the range having the same mail address (domain name portion) as the domain name of the mail server is shown as “inside the organization 110”, it is alternatively possible to designate a plurality of domain names (i.e. a plurality of IP addresses) as “inside the organization”. Still alternatively, it is possible to classify a same domain name into ranges by a mail user account, to designate each range as “inside the organization” or “outside the organization”. In other words, definition of “inside the organization” and “outside the organization” is a matter of definition of a user range managed as “inside the organization”, and can be defined arbitrarily.

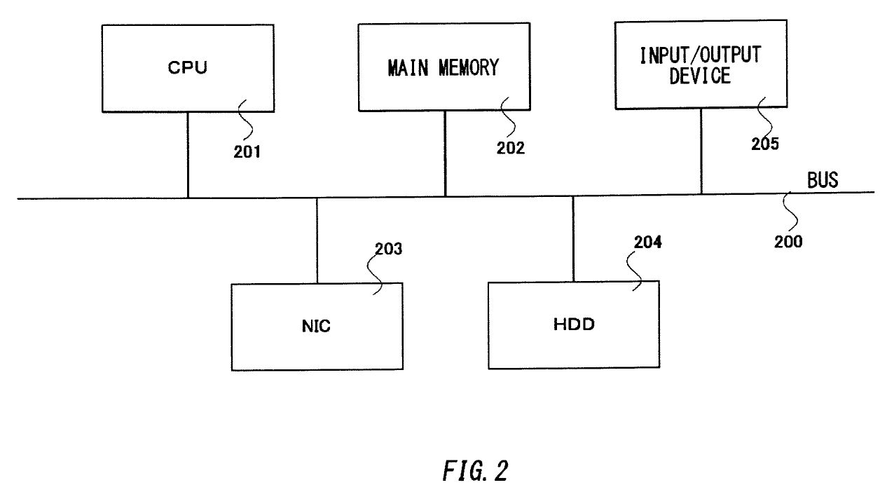

FIG. 2 is a block diagram showing one example of a hardware overview of a server system 111. A CPU (central processing unit) 201, a main memory 202, a NIC 203, a HDD (hard disk drive) 204, and an input/output device 205 are connected to each other via a bus 200. The structure of the bus 200 is arbitrary, and is structurable by combining an internal bus, a PCI bus, etc. that are general, in a hierarchical manner. The CPU 201 executes a data operation according to a program. The main memory 202 memorizes data or a program, and provides a work area for a program executed by the CPU 201. The NIC 203 executes an interface with a network. The HDD 204 is a memory, which memorizes an OS or other programs described later, or memorizes data of a database and so on. The configuration and the operation of each hardware unit is well known to a person ordinarily skilled in the related art, and so the detailed description thereof is omitted here. The HDD 204 and the input/output device 205 are connected to the bus 200 via an adequate I/O (input/output interface), however the explanation thereof is omitted here. An exemplary input/output device 205 includes an input device such as a keyboard, a mouse, and a tablet, an output device such as a liquid crystal display, and a recorder such as a CD-ROM, and a DVD-ROM.

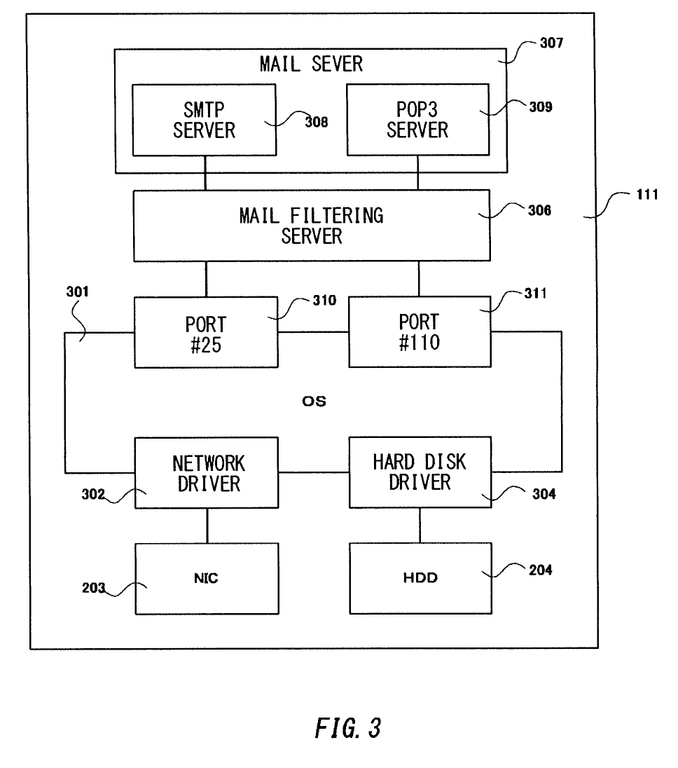

FIG. 3 is a block diagram showing one example of a function of the server system 111. An adequate OS (operating system) 301 is installed in the server system 111. The OS 301 controls data exchange with the NIC 203 via the network driver 302. In addition, the OS 301 writes data to the HDD 204 via the hard disk driver 304, and reads data from the HDD 204. The network driver 302 and the hard disk driver 304 control the NIC 203 and the HDD 204, respectively.

On the OS 301, the mail filtering server 306 and the mail server 307, being an application program, operate. The mail filtering server 306 is detailed later. The mail server 307 is a combination of an SMTP server 308 and a POP3 server 309. The SMTP server 308 transmits and receives mail data based on a simple mail transfer protocol (smtp). The POP3 server 309 transfers a mail received based on a post office protocol (pop) to a local computer. Note that although a POP 3 server is used to read a received mail in this example, it is alternatively possible to use an IMAP (Internet message access protocol) server.

#25 (25^{th} port 310) is designated to mail data transmitted or received based on the smtp as a normal application port. In addition, #110 (100^{th} port 311) is designated to the mail data transferred based on the pop as a normal application port. In the present embodiment, data of this 25^{th} port 310 and the 110^{th} port 311 is received by the mail filtering server 306. That is, the 25^{th} port 310 and the 110^{th} port 311 are designated as an application port of the mail filtering server 306. Data transfer (inter-process communication) from the mail filtering server 306 to the mail server 307 is realized by changing the application port of the mail server 307 to a registration port of equal to or more than #1025, and by transferring the data from the mail filtering server 306 to this registration port. Note that the mail server 307 can be operated in a server system different from the mail filtering server 306. In this case, inter-process communication between the mail filtering server 306 and the mail server 307 can be performed by designating an IP address of the server system, where it is not necessary to change the default port number of the mail server 307.

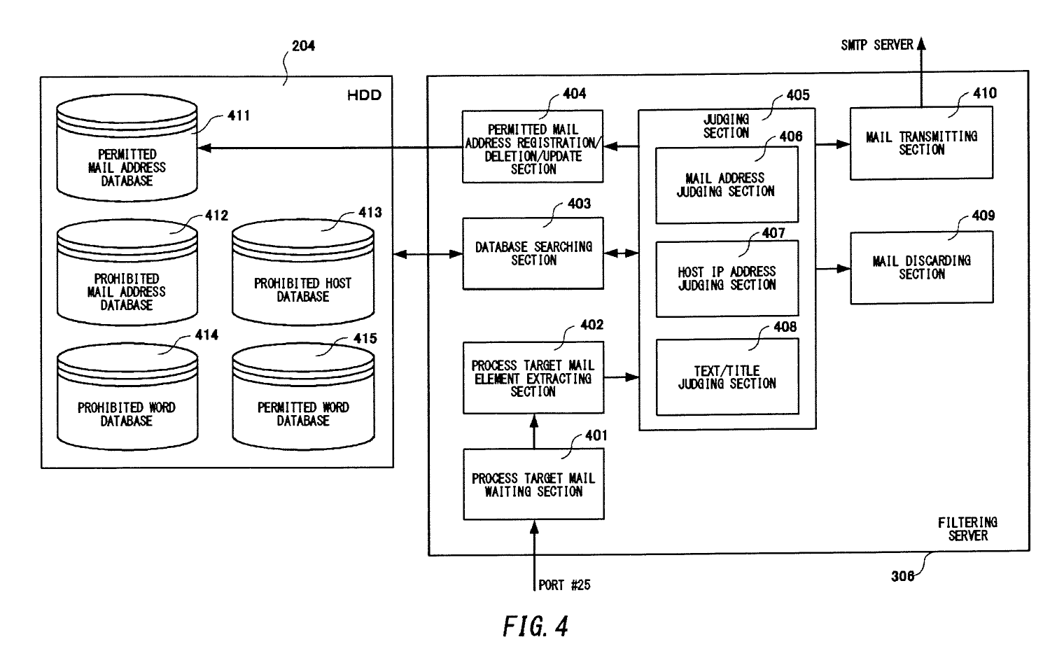

FIG. 4 a block diagram showing one example of a mail filtering server 306. The mail filtering server 306 includes a process target mail waiting section 401, a process target mail element extracting section 402, a database searching section 403, a permitted mail address registration/deletion/update section 404, a judging section 405, a mail discarding section 409, and a mail transmitting section 410, where the judging section 405 includes a mail address judging section 406, a host IP address judging section 407, and a text/title judging section 408. In addition, the HDD 204 records thereon a permitted mail address database 411, a prohibited mail address database 412, a prohibited host database 413, a prohibited word database 414, and a permitted word database 415.

The process target mail waiting section 401 waits for receiving data from the 25^{th} port 310, and starts processing detailed later when receiving mail data. The process target mail element extracting section 402 extracts, from the received mail data, elements such as a transmission source mail address, a transmission destination mail address, an IP address of a transmission source host, and words contained in the mail text or the mail title. The database searching section 403 searches each database recorded in the HDD 204. The permitted mail address registration/deletion/update section 404 controls registration, deletion, and update of a mail address with respect to a permitted mail address database. The mail address judging section 406 judges whether the mail address extracted by the process target mail element extracting section 402 matches the mail address found as a result of searching by the database searching section 403. The host IP address judging section 407 judges whether the host IP address extracted by the process target mail element extracting section 402 matches the host IP address found as a result of searching by the database searching section 403. The text/title judging section 408 judges whether the word extracted by the process target mail element extracting section 402 matches the word found as a result of searching by the database searching section 403. The mail discarding section 409 discards mail data received in accordance with a judgment result detailed later, and the mail transmitting section 410 transmits (transfers) mail data received in accordance with the judgment result, to the mail server 307.

The permitted mail address database 411 records thereon a mail address where reception of a mail from the mail address is permitted. The prohibited mail address database 412 records thereon a mail address where reception of a mail from the mail address is prohibited. The prohibited host database 413 records thereon a host IP address where reception of a mail from the host IP address is prohibited. The prohibited word database 414 records thereon a word where reception of a mail that contains the word is prohibited, and the permitted word database 415 records thereon a word where reception of a mail that contains the word is permitted.

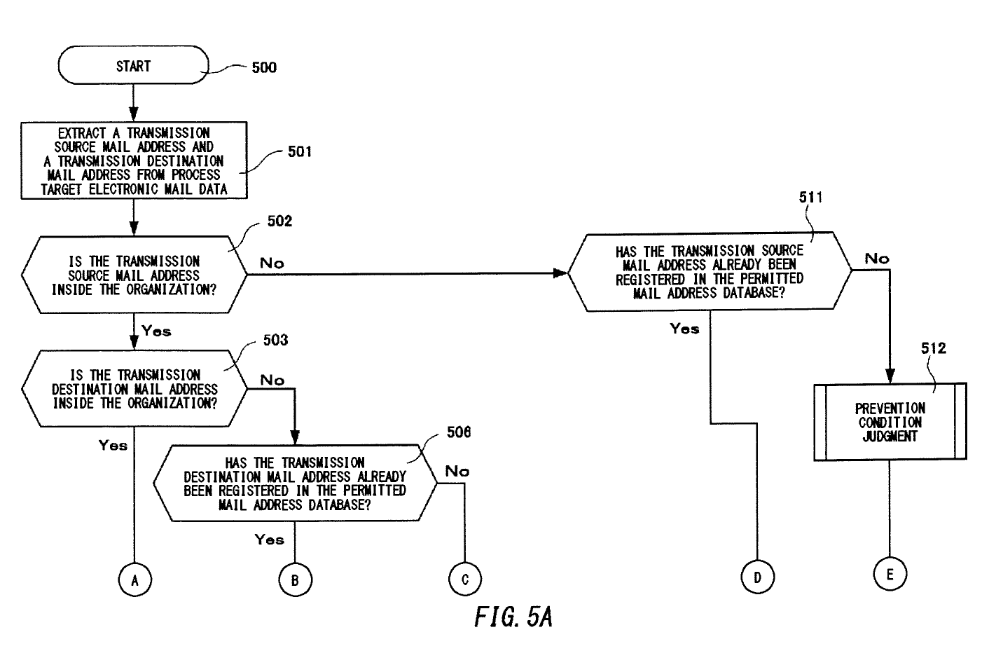

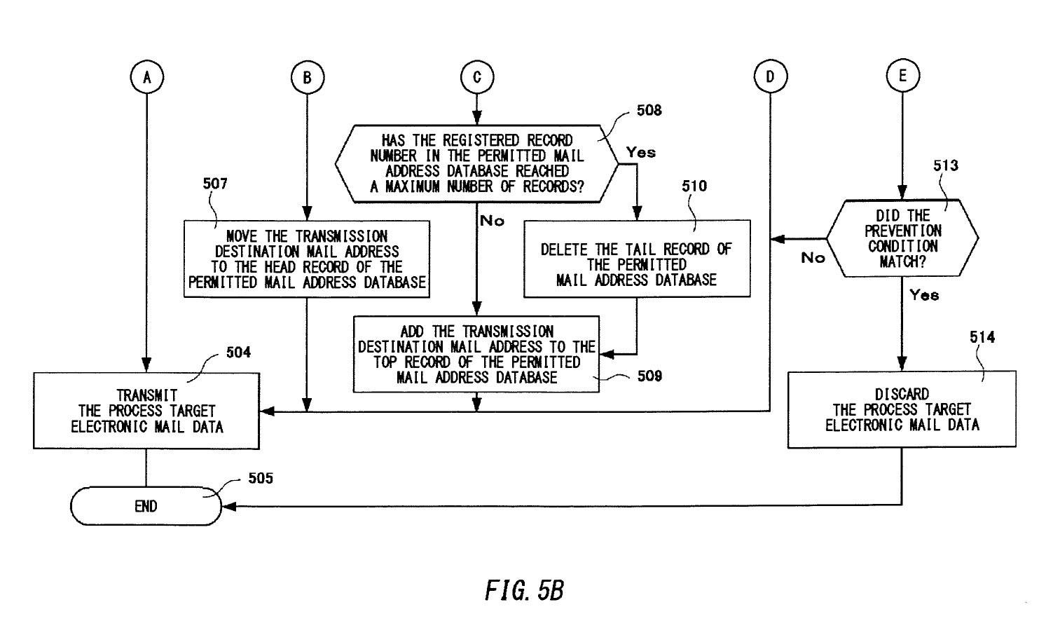

Next, an electronic mail processing method in an electronic mail processing system according to the present embodiment is described. FIG. 5A and FIG. 5B are a flowchart showing one example of an electronic mail processing method according to the present embodiment. First, the process target mail waiting section 401 starts by reception of an electronic mail (Step 500). The process target mail element extracting section 402 extracts, from the received electronic mail data, a transmission source mail address and a transmission destination mail address (Step 501). It is judged whether the extracted transmission source mail address is inside an organization (Step 502), if it is judged to be inside the organization, it is further judged whether the transmission destination mail address is inside the organization (Step 503). If this judgment results in the positive, then it is possible to judge that both of the transmission source and the transmission destination are inside the organization, and that it is a mail transmission/reception inside the organization. Since it is substantially impossible that a junk mail originates from inside the organization, the electronic mail data received from the mail transmission section 410 is transmitted (transferred) to the mail server 307 as it is, without no further judgment (Step 504). Then the processing ends (Step 505).

When it is judged that the transmission destination mail address is not inside the organization in Step 503 (i.e. when the mail transmission is from inside the organization to outside the organization), the control proceeds to Step 506, where processing to record the transmission destination mail address is performed. When performing electronic mail transmission from inside the organization to outside the organization, it is substantially impossible that the mail is a junk mail, and that it is possible to presume that the mail is destined to a reliable destination, and therefore the transmission destination mail address is recorded as a permitted mail address. Recording of a permitted mail address (permitted mail address database) is useful in a later stage to judge that an electronic mail coming from the same destination is not a junk mail.

In Step 506, it is judged whether the transmission destination mail address has already been registered in the permitted mail address database (Step 506). If having been already registered, the transmission destination mail address is moved to a head record in the permitted mail address database (Step 507), and the control proceeds to Step 504. When not having been registered yet, registration processing is newly performed. In the registration processing, it is judged whether a registration record number in the permitted mail address database has reached a maximum number (Step 508). When it is judged not having reached a maximum number, additional registration is performed so that the transmission destination mail address is registered to a head record of the permitted mail address database (Step 509). When it is judged to have reached a maximum number, after deleting the tail record of the permitted mail address database (Step 510), additional registration to the head record is performed (Step 509). After Step 509, the control proceeds to Step 504.

Note that registration of a transmission destination mail address to the permitted mail address database is automatically performed. In other words, it is possible to improve the accuracy of filtering (unk mail countermeasure) by making use of a registered mail address without putting any burden on a user. In addition, by processing as in Step 506-Step 510, it is possible to record a mail address having higher transmission frequency to a record nearer to the head record of the permitted mail address database. This makes it harder to delete a mail address having higher transmission frequency and having more importance. Conversely, a mail address having lower transmission frequency will gradually approach the tail record of the permitted mail address database, and when having become the tail record, the mail address is to be deleted. All the operations such as registration, deletion, and change destined to the permitted mail address database are performed automatically, and that a more important mail address is to be stored nearer to the top record. The permitted mail address database according to the present embodiment is able to selectively store an important mail address eventually, without putting any burden on a user.

In Step 502, when the transmission source mail address is judged not inside the organization, the process target electronic mail data is transmitted from outside the organization, and so has a high possibility of including a junk mail. In view of this, filtering for junk mail countermeasure is applied from Step 511. In Step 511, it is judged whether the transmission source mail address is registered in the permitted mail address database (Step 511). When the judgment in Step 511 results in the affirmative, this electronic mail is an electronic mail transmitted from a reliable source, and so has an extremely low possibility of being a junk mail. Therefore, the control proceeds to Step 504, to transmit (transfer) the process target electronic mail data to the mail server 307 (Step 504), then the processing ends (Step 505).

If the judgment in Step 511 results in the negative, normal filtering processing is performed. In the normal filtering processing, it is judged whether the process target electronic mail data corresponds to a prevention condition (Step 512), when corresponding to the prevention condition (Step 513), the process target electronic mail data is discarded (Step 514), and the processing ends (Step 505). When not corresponding to the prevention condition (Step 513), the process target electronic mail data is transmitted (transferred) to the mail server 307 (Step 504), and the processing ends (Step 505).

The prevention condition in Step 512 is able to be constructed to be complicated by setting a multitude of condition items. As the condition is constructed to be more complicated, more detailed condition setting is enabled and accuracy in preventing a junk mail can be improved. On the other hand, although the possibility of erroneously deleting necessary mail data in reality as the condition is constructed to be more complicated, processing in Step 511 and Step 504 in the present embodiment is able to pass necessary electronic mail data prior to the prevention condition judgment, and so the probability of erroneously preventing necessary mail data can be restrained to be substantially small.

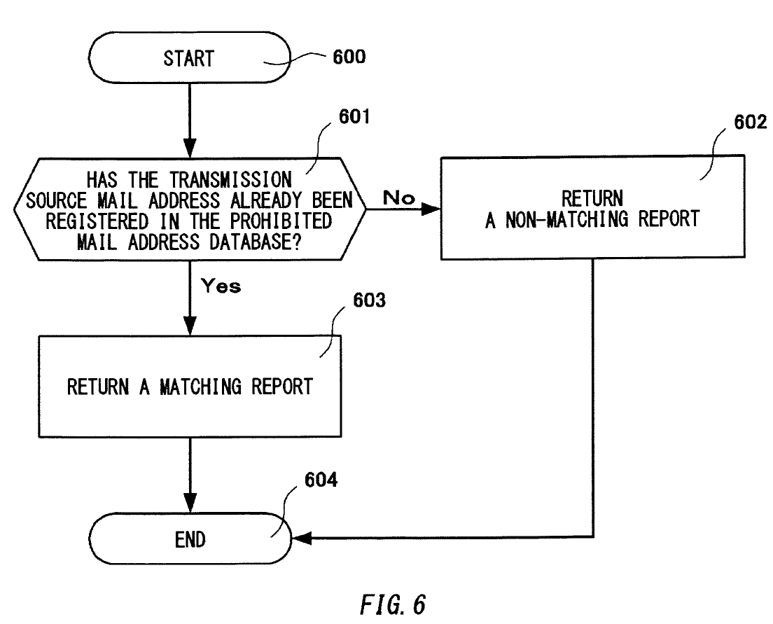

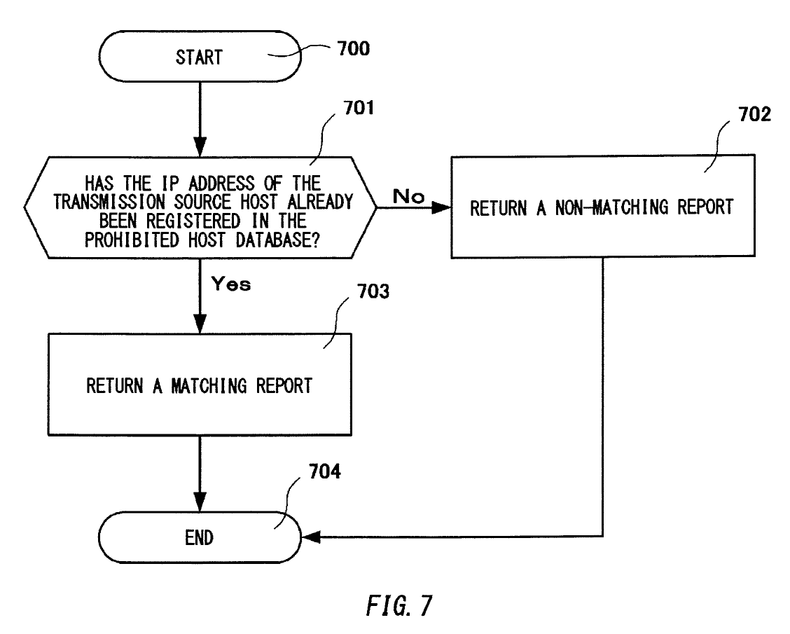

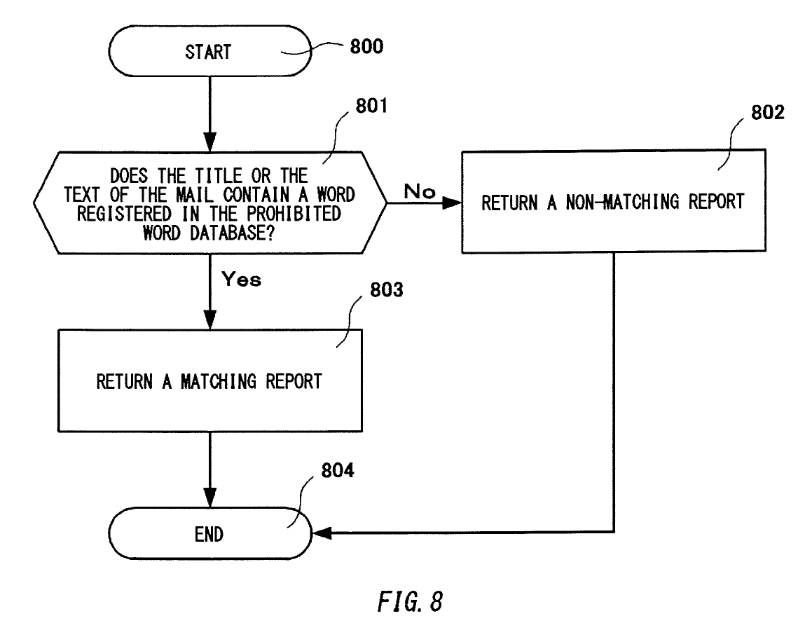

The following are relatively simple examples of the prevention condition in Step 512. For example in the flowchart of FIG. 6, the adopted prevention condition is that a transmission source mail address has been registered in the prohibited mail address database (Step 601). In the flowchart of FIG. 7, the adopted prevention condition is that the IP address of the transmission source host has been registered in the prohibited host database (Step 701). In the flowchart of FIG. 8, the adopted prevention condition is that the title or the text of the mail contains a word registered in the prohibited word database (Step 801). In any of the examples in FIG. 6-FIG. 8, when corresponding registration is found in the corresponding prohibited database, it is considered to match the prevention condition.

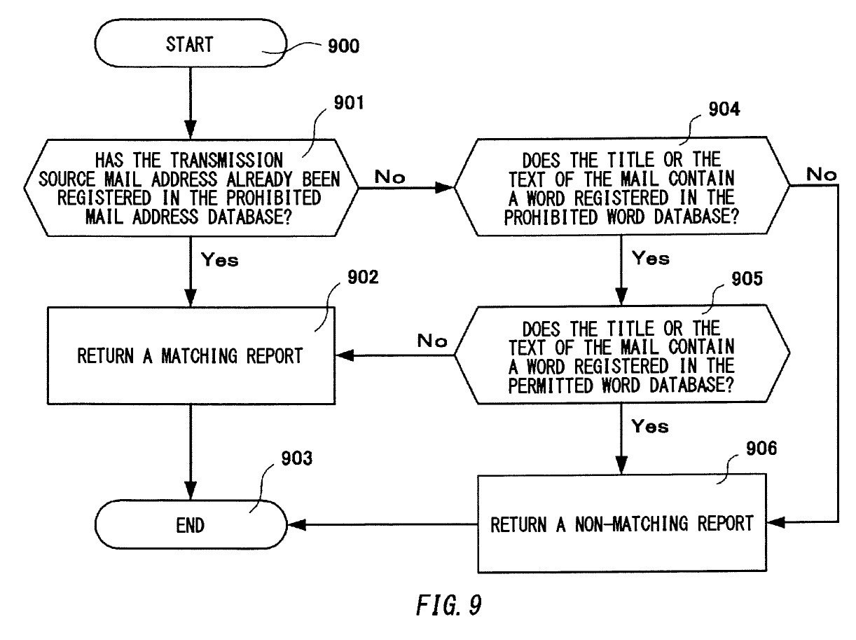

The flowchart in FIG. 9 exhibits a little more complicated prevention condition. When a transmission source mail address does not match a registration in the prohibited mail address database (Step 901: No), it is further judged whether the mail title or the mail text contains a prohibited word (Step 904). Here, if it is judged that no prohibited word is contained, it is judged not to match the prevention condition (Step 906). However even if it is judged that a prohibited word is contained, it is further judged whether the mail title or the mail text contains a permitted word (Step 905). If a permitted word is contained, it is judged not to match the prevention condition (Step 906). In other words, if the mail title or the mail text contains a prohibited word, it is judged to match the prevention condition in principle. However, even when a prohibited word is contained, it is considered not to match the prevention condition if a permitted word is simultaneously contained.

Although some aspects of the present invention have been described by way of exemplary embodiments, it should be understood that those skilled in the art might make many changes and substitutions without departing from the spirit and the scope of the present invention which is defined only by the appended claims.

According to an aspect of the innovations herein, it is possible to avoid erroneously applying a prevention condition in the junk mail countermeasure. Accordingly, it is possible to provide a mail filtering technology by which a necessary electronic mail in reality is reliably passed.

What is claimed is:

1. An electronic mail processing method, comprising:
receiving process target electronic mail data;
when the electronic mail data is attempted to be transmitted from inside an organization to outside the organization, recording a transmission destination mail address of the electronic mail data to a permitted mail address database, and transmitting the electronic mail data; and
when the electronic mail data is attempted to be transmitted from outside the organization to inside the organization and a transmission source mail address of the electronic mail data is recorded in the permitted mail address database, transmitting the electronic mail data.

2. The electronic mail processing method as set forth in claim 1, further comprising:
when the electronic mail data is attempted to be transmitted from outside the organization to inside the organization and a transmission source mail address of the electronic mail data is not recorded in the permitted mail address database, judging a prevention condition, transmitting the electronic mail data if the prevention condition does not match, and discarding the electronic mail data if the prevention condition matches.

3. The electronic mail processing method as set forth in claim 2, wherein
the prevention condition matches when the transmission source mail address of the electronic mail data is registered in a prohibited mail address database.

4. The electronic mail processing method as set forth in claim 2, wherein
the prevention condition matches when an IP address of a transmission source host of the electronic mail data is registered in a prohibited host database.

5. The electronic mail processing method as set forth in claim 2, wherein
the prevention condition matches when a word contained in a title or a text of the electronic mail data is registered in a prohibited word database.

6. The electronic mail processing method as set forth in claim 2, wherein
the prevention condition does not match even when a word contained in a title or a text of the electronic mail data is registered in a prohibited word database, if the word is registered in a permitted word database.

7. The electronic mail processing method as set forth in claim 1, wherein recording the transmission destination mail address of the electronic mail data to the permitted mail address database includes:
when the transmission destination mail address is already recorded in the permitted mail address database, moving the transmission destination mail address to a head record of the permitted mail address database, and
when the transmission destination mail address is not recorded in the permitted mail address database and a number of recorded records in the permitted mail address database has reached a maximum number of records, deleting a tail record of the permitted mail address database, and recording the transmission destination mail address as a head record of the permitted mail address database.

8. The electronic mail processing method as set forth in claim 1, further comprising:
when a transmission source of the electronic mail data is inside the organization and a transmission destination of the electronic mail data is inside the organization, transmitting the electronic mail data without referring to the permitted mail address database.

9. An electronic mail processing system, comprising:
a unit operable to receive process target electronic mail data;
a unit operable to, when the electronic mail data is attempted to be transmitted from inside an organization to outside the organization, record a transmission destination mail address of the electronic mail data to a permitted mail address database, and to transmit the electronic mail data; and
a unit operable to, when the electronic mail data is attempted to be transmitted from outside the organization to inside the organization and a transmission source mail address of the electronic mail data is recorded in the permitted mail address database, transmit the electronic mail data.

10. The electronic mail processing system as set forth in claim 9, further comprising:
a unit operable to, when the electronic mail data is attempted to be transmitted from outside the organization to inside the organization and a transmission source mail address of the electronic mail data is not recorded in the permitted mail address database, judge a prevention condition, transmit the electronic mail data if the prevention condition does not match, and discard the electronic mail data if the prevention condition matches.

11. The electronic mail processing system as set forth in claim 10, wherein
the prevention condition matches when the transmission source mail address of the electronic mail data is registered in a prohibited mail address database.

12. The electronic mail processing system as set forth in claim 10, wherein
the prevention condition matches when an IP address of a transmission source host of the electronic mail data is registered in a prohibited host database.

13. The electronic mail processing system as set forth in claim 10, wherein
the prevention condition matches when a word contained in a title or a text of the electronic mail data is registered in a prohibited word database.

14. The electronic mail processing system as set forth in claim 10, wherein
the prevention condition does not match even when a word contained in a title or a text of the electronic mail data is registered in a prohibited word database, if the word is registered in a permitted word database.

15. The electronic mail processing system as set forth in claim 9, wherein recording the transmission destination mail address of the electronic mail data to the permitted mail address database includes:
when the transmission destination mail address is recorded in the permitted mail address database, moving the transmission destination mail address to a head record of the permitted mail address database, and
when the transmission destination mail address is not recorded in the permitted mail address database and a number of recorded records in the permitted mail address database has reached a maximum number of records, deleting a tail record of the permitted mail address database, and recording the transmission destination mail address as a head record of the permitted mail address database.

16. The electronic mail processing system as set forth in claim 9, further comprising:
a unit operable to, when a transmission source of the electronic mail data is inside the organization and a transmission destination of the electronic mail data is inside the organization, transmit the electronic mail data without referring to the permitted mail address database.
